(19) United States
(12) Patent Application Publication
(10) Pub. No.: US 2026/0156692 A1
(43) Pub. Date: Jun. 4, 2026

(54) USER PLANE FUNCTION SELECTION BASED ON SERVICE TYPE FOR PACKET DATA UNIT SESSIONS

(71) Applicant: RAKUTEN MOBILE, INC., Tokyo (JP)

(72) Inventors: Sumanmishra PRABHAT, Tokyo (JP); Ryo WATANABE, Tokyo (JP); Akarsh SRIVASTAVA, Tokyo (JP)

(73) Assignee: RAKUTEN MOBILE, INC., Tokyo (JP)

(21) Appl. No.: 18/706,572

(22) PCT Filed: Mar. 6, 2024
(86) PCT No.: PCT/US2024/018595

§ 371 Date: May 1, 2024

(30) Foreign Application Priority Data
Aug. 24, 2023 (IN) 202341056762

(51) Int. Cl. H04W 76/10; H04W 60/00; H04W 88/14

(52) U.S. Cl. CPC H04W 76/10; H04W 60/00; H04W 88/14

(57) ABSTRACT

Embodiments of the present disclosure disclose user plane function selection based on service type for packet data unit sessions. The network repository element (106) receives a UPF request from a network session element (122) for detecting one or more UPFs from the plurality of UPFs. The UPF request comprises at least a UPF service type. The network repository element (106) is configured to identify the one or more UPFs from the plurality of UPFs based on the UPF service type. The network repository element (106) is configured to send information related to the one or more UPFs to the network session element (122). The network session element (122) is configured to identify a UPF from the one or more UPFs based on the information and one or more selection parameters for facilitating a Packet Data Unit (PDU) session.

### TECHNICAL FIELD

The present disclosure generally relates to communication technologies, and more specifically, user plane function selection based on service type for packet data unit sessions.

### BACKGROUND

Modern communication systems, such as the 5G mobile communication technology, has revolutionized a wide variety of industries with its increased speed, reduced latency and improved reliability. The 5G mobile communication technology has a mobile core infrastructure specified by the 3rd Generation Partnership Project's (3GPP's) New Radio (NR) which decouples functionality of the packet data network gateway (PGWs) between a control plane and a user plane. Such a split architecture of PGWs in the 5G core network allow independent scalability, evolution and flexible deployment of the user plane and the control plane. In the 3GPP specifications. PGW user plane functions are also referred to as User Plane Functions (UPFs) which act as an anchor point for a Packet Data Unit (PDU) data session. In general, the User Equipment (UE) needs to access the UPF of the 5G core network through the Radio Access Network (RAN), so that it can access the Data Network (DN). As such, an important aspect in establishing the PDU data session is the selection of UPF for accessing the 5G core network. Typically, selection of an UPF is performed by the control plane based on various information including location, service, capabilities and load. More specifically, a network element i.e., such as a Session Management Function (SMF) of the 5G core network obtains information of one or more UPFs, and selects one or more UPF for facilitating the PDU session.

In view of the above discussion, there exists a need to identifying a UPF for efficiently facilitating the PDU session which improves a users' mobile internet experience.

The information disclosed in this background of the disclosure section is only for enhancement of understanding of the general background of the disclosure and should not be taken as an acknowledgement or any form of suggestion that this information forms the prior art already known to a person skilled in the art.

### SUMMARY

In general, User Plane Function (UPF) selection functionality in the Session Management Function (SMF) may utilize a Network Repository Function (NRF) to discover UPF instance(s). However, some SMFs may require a specific UPF(s) or a group of UPF(s) for a specific application or a specific type of subscribers.

In an embodiment, a network repository element is disclosed. The network repository element includes a memory and a processor. The memory is configured to store instructions and a plurality of User Plane Functions (UPFs) registered with the network repository element. The processor is configured to execute the instructions stored in the memory to: receive a UPF request from a network session element for detecting one or more UPFs from the plurality of UPFs. The UPF request includes at least a UPF service type. The processor is configured to identify the one or more UPFs from the plurality of UPFs based on the UPF service type. The processor is configured to send information related to the one or more UPFs to the network session element. The processor is configured to identify a UPF from the one or more UPFs based on the information and one or more selection parameters for facilitating a Packet Data Unit (PDU) session.

In another embodiment, a method is disclosed. The method includes receiving, by a network repository element, a UPF request from a network session element for detecting one or more UPFs from a plurality of UPFs registered with the network repository element. The UPF request includes at least a UPF service type. The method includes identifying, by the network repository element, the one or more UPFs from the plurality of UPFs based on the UPF service type. The method includes sending, by the network repository element, information related to the one or more UPFs to the network session element. The network session element is configured to identify a UPF from the one or more UPFs based on the information and one or more selection parameters for facilitating a Packet Data Unit (PDU) session.

In yet another embodiment, a system is disclosed. The system includes a network session element and a network repository element. The network repository element stores a plurality of User Plane Functions (UPFs) registered with the network repository element. The network repository element is communicably coupled with the network session element. The network repository element is configured to receive a UPF request for detecting one or more UPFs from the plurality of UPFs. The UPF request includes at least a UPF service type. The network repository element is configured to identify the one or more UPFs from the plurality of UPFs based on the UPF service type. The network repository element is configured to send information related to the one or more UPFs to the network session element. The network session element is configured to identify a UPF from the one or more UPFs based on the information and one or more selection parameters for facilitating a Packet Data Unit (PDU) session.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. The same numbers are used throughout the figures to reference like features and components. Some embodiments of device and/or methods in accordance with embodiments of the present subject matter are now described, by way of example only, and with reference to the accompanying figures, in which:

FIG. 1 illustrates a schematic representation of a 5G communication system architecture, where some embodiments of the present disclosure may be practiced;

FIG. 2 illustrates a network element for selecting User Plane Function based on a service type for Packet Data Unit (PDU) sessions, in accordance with an embodiment of the present disclosure;

FIG. 3 illustrates a sequence flow diagram representing a method for registration of a User Plane Function (UPF) with a network repository element, in accordance with an embodiment of the present disclosure;

FIG. 4 illustrates a sequence flow diagram representing a method for identifying a User Plane Function (UPF) for facilitating a Packet Data Unit (PDU) session, in accordance with an embodiment of the present disclosure;

FIG. 5 illustrates a sequence flow diagram representing an exemplary method for identifying one or more User Plane Functions (UPFs) from the plurality of UPFs based on a UPF service type international roaming, in accordance with an embodiment of the present disclosure;

FIG. 6 illustrates a network session element for User Plane Function (UPF) selection based on service type for Packet Data Unit (PDU) sessions, in accordance with an embodiment of the present disclosure;

FIG. 7 illustrates a network repository element for User Plane Function (UPF) selection based on service type for Packet Data Unit (PDU) sessions, in accordance with an embodiment of the present disclosure; and

FIG. 8 is a flowchart illustrating a method for User Plane Function (UPF) selection based on service type for Packet Data Unit (PDU) sessions, in accordance with an embodiment of the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration”. Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

It shall be noted that, for convenience of explanation, the disclosure uses terms and names defined in the 3rd Generation Partnership Project Radio Access Network (3GPP RAN) standards. More specifically, the terms ‘Service-Based Architecture’, ‘Service-Based Interface’, ‘Service-Level Agreement (SLA) criterion’, ‘Non-Public Network (NPN)’, ‘packet data network gateway’, ‘Packet Data Unit session’ and ‘Data Network’ are to be interpreted as specified by the 3GPP RAN standards.

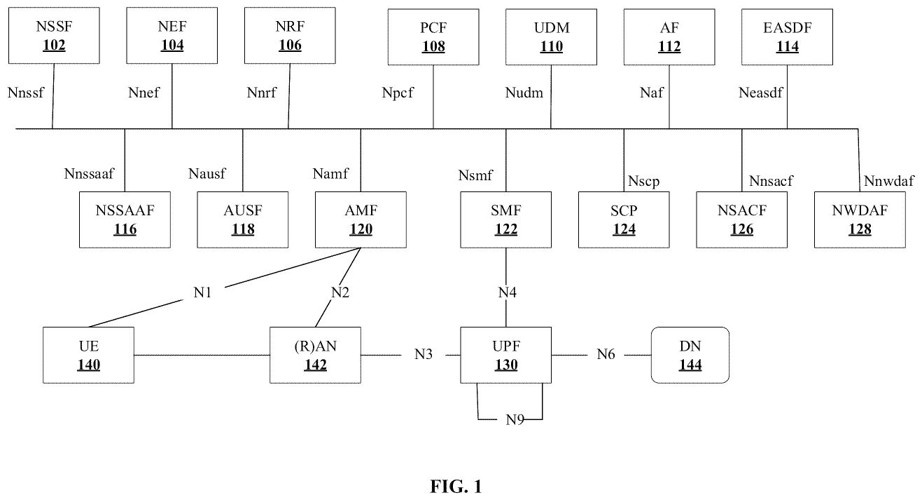

The term “User Plane Function (UPF) selection” as used herein refers to identifying one or more UPFs for Packet Data Unit (PDU) sessions. More specifically, the one or more UPFs are selected from among a plurality of UPFs based on at least a service type. In an embodiment, the service type may be specified by the Session Management Function (SMF). In an example, the SMF may specify the service type based on at least an User Equipment requesting access to the Data Network (DN). In another embodiment, SMF may specify one or more service types of UPF for storing UPF profiles. UPF function selection based on service type is explained in detail with reference to FIGS. 1-8.

FIG. 1 illustrates a schematic architecture 100 of a 5G communication system, where some embodiments of the present disclosure may be practiced. The architecture 100 uses a cloud-aligned service-based architecture (SBA) to support authentication, security, session management and aggregation of traffic from connected devices, all of which requires the complex interconnection of network functions which form a 5G core.

Accordingly, the 5G core includes a plurality of interconnected Network Functions which are defined by the 3GPP for delivering the control plane functionality and user plane functionality of the 5G communication system. In general, the plurality of interconnected Network Functions (NFs) are interconnected Network Functions with each NF authorized to access the services of other NFs. These plurality of Network Functions (or NFs) are hereinafter interchangeably referred to as ‘network element’ throughout the description. Further, for purpose of the present disclosure the term ‘NF Network Repository Function’ is interchangeably referred to as ‘NRF’ or ‘network repository element’ and the term ‘Session Management Function’ is interchangeably referred to herein as ‘SMF’ or ‘network session element’ throughout the disclosure.

The architecture 100 of the 5G communication system depicts a Network Slicing Selection Function 102 (referred to herein as ‘NSSF 102’), a Network Exposure Function 104 (referred to herein as ‘NEF 104’), a NF Repository Function 106 (referred to herein as ‘NRF 106’), a Policy Control Function 108 (referred to herein as ‘PCF 108’), an Unified Data Management 110 (referred to herein as ‘UDM 110’), an Application Function 112 (referred to herein as ‘AF 112’), an Edge Application Server Discovery Function 114 (referred to herein as ‘EASDF 114’), a Network Slice Specific Authentication and Authorization Function 116 (referred to herein as ‘NSSAAF 116’), an Authentication Server Function 118 (referred to herein as ‘AUSF 118’), an Access and Mobility Management Function 120 (referred to herein as ‘AMF 120’), a Session Management Function 122 (referred to herein as ‘SMF 122’), a Service Communication Proxy 124 (referred to herein as ‘SCP 124’), a Network Slice Admission Control Function 126 (referred to herein as NSACF 126′), a Network Data Analytics Function 128 (referred to herein as ‘NWDAF 128’), an User Plane Function 130 (referred to herein as ‘a UPF 130’). The NSSF 102, the NEF 104, the NRF 106, the PCF 108, the UDM 110, the AF 112, the EASDF 114, the NSSAAF 116, the AUSF 118, the AMF 120, the SMF 122, the SCP 124, the NSACF 126 and the NWDAF 128 and functions of these network elements are defined by the 3GPP standard and are not explained herein for the sake of brevity. It shall be noted that each of these NFs 102-128 may be implemented using hardware, software, firmware or any combinations thereof.

The User Equipment 140 (hereinafter referred to as ‘UE 140’) is configured to connect over the Radio Access Network (RAN) 142 to the 5G core comprising the plurality of network elements 102-128. Examples of the UE 140 include, but not limited to, any device used by a user to communicate and/or access content such as, but not limited to, mobile phones, smartphones, laptops, wearables. Internet of Things (IoTs), and the like with 5G capabilities. As such, the UE 140 is configured to connect to Data Networks 144 (also referred to herein as ‘DN 144’) through which operator services, 3rd party services, etc. can be accessed by the UE 140. An example of the DN 144 is the Internet. The AMF 120 acts as a single-entry point for the UE 140 to connect with the 5G core.

As depicted in FIG. 1, each network element of the plurality of network elements 102-128 exposes its respective functionality through a Service-Based Interface (SBI). For example, the NSSF 102 exposes functionality via Nnssf interface, the NEF 104 exposes functionality via Nnef interface, the NRF 106 exposes functionality via Nnrf interface, the PCF 108 exposes functionality via Npcf interface, the UDM 110 exposes functionality via Nudm interface, the AF 112 exposes functionality via Naf interface, the EASDF 114 exposes functionality via Neasdf interface, the NSSAAF 116 exposes functionality via Nnssaaf interface, the AUSF 118 exposes functionality via Nausf interface, the AMF 120 exposes functionality via Namf interface, the SMF 122 exposes functionality via Nsmf interface, the SCP 124 exposes functionality via Nscp interface, the NSACF 126 exposes functionality via Nnsacf interface and the NWDAF 128 exposes functionality via Nnwdaf interface.

Further, N1 is an interface between the UE 140 and the AMF 120, N2 is an interface between the Radio Access Network (RAN) 142 (i.e., gNodeB) and the AMF 120, N3 interface performs the role of conveying user data from the RAN 142 to the UPF 130, N4 interface is the bridge between the control plane and the user plane of the 5G core, N6 interface provides connectivity between the UPF 130 and the DN 144 (i.e., any other external or internal networks or service platforms, such as the Internet, the public cloud or private clouds), and N9 provides an Interface between two UPF's (i.e., the Intermediate I-UPF and the UPF Session Anchor).

The UE 140 needs to access the UPF 130 of the 5G core network through the RAN 142, so that it can access the DN 144. As such, for establishing a PDU session, selection of the UPF 130 is necessary for accessing the 5G core network. There are many ways for the UE 140 to select an UPF for accessing the DN 144 after accessing the 5G core network.

Conventionally, TS 23.501 of 3GPP specifies selection of the UPF by the SMF 122 by optionally utilizing the NRF 106 to discover UPF instance(s) for establishing the PDU session. In this case, the SMF 122 issues a request including parameters such as Data Network Name (DNN), Single-Network Slice Selection Assistance Information (S-NSSAI), SMF Area Identity, Access Traffic Steering, Switching and Splitting (ATSSS) steering capabilities to the NRF 106. In response, the NRF 106 provides a list of available UPF(s) to the UE 140 for establishing the PDU session. However, the list of UPF shared by the NRF 106 are not specific for service types.

In an example scenario, a user of the 5G communication system may be an enterprise subscriber for services availed by the UE 140. As such, the UE 140 may be entitled for enabling connectivity and advanced functionality. In an instance, the UE 140 may have an option to send media content including promotional offers for display in real-time at recipient mobile devices (i.e., current or prospective enterprise customers). In another instance scenario, the user may be an Internet of Things (IoT) subscriber in the 5G communication system. As such, the UE 140 associated with the user may require services which are ultra-reliable and have low-latency. In such scenarios, a dedicated UPF supporting such services for the users may be beneficial. In other cases, a framework that allows for assignment of dedicated UPF resources to specific services or specific subscribers or groups of subscribers (e.g., to enable service independence and isolation) may be beneficial. Typically, a UPF may be selected based on one or more selection parameters such as, UPF's dynamic load, UPF's location, UPF relative static capacity, UPF service location, service type, resource specifications, and the like. However, user requirements for specific services do not influence selection of the UPF.

Various embodiments of the present disclosure disclose techniques for UPF selection based on service type for packet data unit sessions. More specifically, UPFs indicate one or more service types while registering with the NRF 106. As such, when a request for UPFs of a specific service type is received from the SMF 122, one or more UPFs from a plurality of UPFs registered with the NRF 106 are identified. Further, the NRF 106 sends information related to the one or more UPFs to the SMF 122. The SMF 122 identifies a UPF from the one or more UPFs based on the information and one or more selection parameters for facilitating a PDU session for the UE 140. Moreover, the NRF 106 identifies suspended UPFs based on a status of each UPF to identify the one or more UPFs thereby ensuring suspended UPFs are not provided for the PDU session. Such techniques of providing UPFs specific to a service type improves overall user experience as such UPFs are equipped to support user requirements such as, reduced latency, faster processing, energy efficiency, enhanced data rates. Quality of Service (QoS) and the like, based on the application as will be explained further with reference to FIGS. 2-8.

FIG. 2 illustrates a network element 200 for UPF selection based on service type for packet data unit sessions, in accordance with an embodiment of the present disclosure. The term ‘service type’ as used herein refers to a category of services which may be provided by a UPF. More specifically, each UPF may be suited to provide one or more specific services based on available resources of corresponding UPF. As such, each service type may depend on one or more of: an application type, a number of users, a mobility of the UE 140, latency requirements, data rates, etc. Some examples of service type include, but not limited to, international roaming, corporate services, enterprise services, Internet of Things (IoTs), immersive gaming, Mobile Network Operator (MNO), Mobile Virtual Network Operator (MVNO), Satellite, Over-The-Top (OTT) based Application services, Private 5G slice, domestic Roaming. Augmented Reality application services. Virtual Reality Application services, smart city services, Multi-Access Edge Computing (MEC), Voice services, and the like. For example, service type may be immersive gaming (e.g., augmented reality, virtual reality, etc.) in which subscribers may require high date rates and low latency which may be supported by specific UPFs among all UPFs registered with a NRF 106. In another example, service type may be IoT in which IoT subscribers require services which are ultra-reliable and have low-latency. Such service types may be used for dedicated UPF selection to enable specific Service Level Architecture. The service type of a UPF is defined as an attribute information element in UpfInfo.

In an embodiment, the network element 200 is a network session element 122. The network session element 122 may be configured to perform functions of the SMF 122 shown in FIG. 1. In an exemplary embodiment, the network session element 122 is referred to as Session Management Function 122 or SMF 122. In another embodiment, the network element 200 is a network repository element 106. The network repository element 106 may be configured to perform functions of the NRF 106 shown in FIG. 1. In an exemplary embodiment, the network repository function 106 is referred to as network repository element 106 or NRF 106. In yet another embodiment, the network element 200 is a system which embodies functions of the SMF 122 and the NRF 106.

As already explained, the network element 200 embodies one or more network functions and is interconnected with the other NFs 102-128 of the 5G core network for UPF selection based on service type for PDU sessions in the architecture 100. The network element 200 is capable of performing one or more of the operations described herein. It shall be noted that embodiments of the present disclosure have been explained herein with reference to the 5G communication system. However, it shall be apparent to a person skilled in the art that techniques adopted by the network element 200 for UPF selection based on service type for PDU sessions may be applied to other communication systems, for example, communication system employing SBAs, for efficiently selecting a UPF based on service type for PDU sessions as will be explained herein. As such, the network element 200 may be a centralized or a distributed server configured to perform the one or more functions of the SMF 122 and/or NRF 106 described herein.

The network element 200 is depicted to include a processor 202, a memory 204, an input/output module 206, and a communication interface 208. It shall be noted that, in some embodiments, the network element 200 may include more or fewer components than those depicted herein. The various components of the network element 200 may be implemented using hardware, software, firmware or any combinations thereof. Further, the various components of the network element 200 may be operably coupled with each other. More specifically, various components of the network element 200 may be capable of communicating with each other using communication channel media (such as buses, interconnects, etc.). In an embodiment, the functions of the NRF 106 and the SMF 122 may be embodied within the processor 202. It shall be noted that the processor 202 may include fewer or more modules than those described herein.

In one embodiment, the processor 202 may be embodied as a multi-core processor, a single core processor, or a combination of one or more multi-core processors and one or more single core processors. For example, the processor 202 may be embodied as one or more of various processing devices, such as a coprocessor, a microprocessor, a controller, a digital signal processor (DSP), a processing circuitry with or without an accompanying DSP, or various other processing devices including, a microcontroller unit (MCU), a hardware accelerator, a special-purpose computer chip, or the like.

In one embodiment, the memory 204 is capable of storing machine executable instructions, referred to herein as instructions 205. In an embodiment, the processor 202 is embodied as an executor of software instructions. As such, the processor 202 is capable of executing the instructions 205 stored in the memory 204 to perform one or more operations described herein.

The memory 204 can be any type of storage accessible to the processor 202 to perform respective functionalities. For example, the memory 204 may include one or more volatile or non-volatile memories, or a combination thereof. For example, the memory 204 may be embodied as semiconductor memories, such as flash memory, mask ROM, PROM (programmable ROM), EPROM (erasable PROM), RAM (random access memory), etc. and the like.

In an embodiment, the memory 204 stores a plurality of UPFs registered with the network repository element 106. In an example, the UPFs may be categorized based on their service type and stored in the memory 204. More specifically, service type profiles may be created for each service type and list of UPFs registered with such service types may be added to the corresponding service type profile.

In an embodiment, when the network element 200 is a network repository element (i.e., NRF 106), the processor 202 is configured to execute the instructions 205 to: (1) receive a registration request from an UPF, (2) register the UPF with the one or more UPF service types, (3) receive a UPF request from the network session element 122 (i.e., SMF 122) for detecting one or more UPFs, (4) determine suspended UPFs based on a status of each UPF of a set of UPFs associated with the at least one service type, (5) identify the one or more UPFs from the plurality of UPFs based on the UPF service type, (6) send information related to the one or more UPFs to the network session element 122, (7) send a notification related to a new UPF registered with the NRF 106. In an embodiment, when the network element 200 is the network session element 122 (i.e., the SMF 122), the processor 202 is configured to execute the instructions 205 to: (1) send a UPF request to the network repository element 106 for detecting one or more UPFs, (2) receive information related to the one or more UPFs from the network repository element 106, (3) identify an UPF from the one or more UPFs based on the information and one or more selection parameters for facilitating a PDU session.

In an embodiment, the I/O module 206 may include mechanisms configured to receive inputs from and provide outputs to an operator of the network element 200 (not shown in FIGS). The term ‘operator of the network element 200’ as used herein may refer to one or more individuals, for example, operators or service providers, whether directly or indirectly, associated with managing the 5G communication system. To enable reception of inputs and provide outputs to the network element 200, the I/O module 206 may include at least one input interface and/or at least one output interface. Examples of the input interface may include, but are not limited to, a keyboard, a mouse, a joystick, a keypad, a touch screen, soft keys, a microphone, and the like. Examples of the output interface may include, but are not limited to, a display such as a light emitting diode display, a thin-film transistor (TFT) display, a liquid crystal display, an active-matrix organic light-emitting diode (AMOLED) display, a microphone, a speaker, a ringer, and the like.

In an embodiment, the communication interface 208 may include mechanisms configured to communicate with other entities in the 5G communication system such as, other network elements (i.e., NFs 102, 104, 106, 108, 110, 112, 114, 116, 118, 120, 122, 124, 126, and 128) for user plane function selection based on service type. In an embodiment, if the network element 200 is the network repository element 106, then inputs are received from network session element 122 (i.e., SMF 122) via the communication interface 208. In another embodiment, if the network element 200 is a network session element 122, then inputs are received from the network repository element (i.e., NRF 106) via the communication interface 208. More specifically, the communication interface 208 is a SBI interface which may be a Nnrf if the network element 200 is a NRF 106 or a Nsmf if the network element 200 is a SMF 122 for interacting with the other network elements (i.e., NFs 102-128) in the architecture 100 depicted in FIG. 1.

In an embodiment, the communication interface 208 may receive a registration request from an UPF for registering with the network repository element 106. The registration request includes one or more UPF service types. In an example, a UPF may indicate a service type as international roaming and premium streaming media. The service type attribute is part of the UpfInfo which will be sent along with the registration request. Such techniques of indicating the UPF service type as part of the registration request ensures the network element 200 (i.e., the network repository element 106) categorizes and stores each of the UPFs based on the service type. In addition, the UPFs of a specific service type may be efficiently retrieved from the network repository element 106 on receipt of a UPF request from another network element (i.e., the session management element 122). In an embodiment, the communication interface 208 may also receive a UPF request from the network session element 122 for one or more UPFs from the plurality of UPFs stored in the network repository element 106. The UPF request includes at least a UPF service type. More specifically, the service type of UPFs required by the network session element 122 is indicated in the UPF request. This ensures that dedicated UPFs may be provisioned for each PDU data session request. In an embodiment, the UPF request may be received as part of a subscription for at least one service type of UPF. Subscription to receive information of UPFs of a specific service type enable receipt of dedicated UPFs for specific service type-either periodically or when new UPFs register with the specified service type. In another embodiment, the UPF request may be received in response to a PDU session request from the UE 140. The PDU session may relate to a specific service type, hence UPF requests which include service type ensure that an appropriate UPF is provided to facilitate the PDU session. For example, if the PDU session relates to media streaming and if the UPF request includes service type of the UPF required for the PDU session (e.g., media streaming), then the UPF which would best support such a service would be provided to the UE 140.

The network element 200 is depicted to be in operative communication with a database 220. In one embodiment, the database 220 is configured to store UPF registration policies for registering one or more UPFs with the network repository element 106. Further, the database 220 stores a plurality of UPF profiles related to a plurality of UPFs. The UPF profiles includes one or more parameters related to the UPF, for example, UPF's dynamic load, UPF's location, UPF relative static capacity, UPF service location, service type, resource specifications, and the like. In an embodiment, the database 220 may also store subscription information received from one or more SMFs (e.g., the SMF 122). The subscription information includes information related to UPFs of at least one specific service type. This ensures the network repository element 106 (i.e., the NRF 106) to send updates when new UPFs of specific service type requested by the NRF 106 registers with the NRF 106. In some embodiments, the subscription may include a request to share information related to UPFs registered with the NRF 106 along with the service type.

The database 220 is also configured to store a status of each UPF. The status of the UPF indicate if the UPF is active or suspended. If the UPF is registered with the NRF 106 but not operative then the status is suspended status. More specifically, if the UPF has not updated its profile for a configurable amount of time (i.e., longer than a heart-beat interval), the NRF 106 changes the status of the UPF to suspended. If the UPF is operational then status of the UPF is active to be discovered by other NFs (i.e., SMF 122). These plurality of UPFs may be registered with the NRF 106 for anchoring PDU session. In an embodiment, the database 220 also includes one or more predefined rules for selection of an UPF for a PDU session. More specifically, these predefined rules indicate various values for each of the one or more selection parameters that are used to select the UPF for the PDU session. Some examples of the selection parameters include, but not limited to, UPF's dynamic load, UPF load prediction, UPF's location, UPF relative static capacity, UE location information, functionality required for the PDU session, Data Network Name (DNN), PDU session type, SSC mode selected for the PDU session, UE subscription profile, local operator policies, access technology used by the UE, user plane latency requirements, and Access Traffic Steering, Switching and Splitting (ATSSS) steering capability for the PDU session, and the like. In an example, the predefined rule may specifically indicate a network resource/parameter that may be a key requirement for a PDU session. For example of a predefined rule to select an UPF from among a set of UPFs with a specific service type may be: select UPF which can serve UE with premium subscription at ‘x’ location with a PDU session spanning 2 hours of immersive video and capable to support data rates of ‘y’ Mbps. It shall be noted that the predefined rule described above is for exemplary purposes and the database 220 may have a plurality of predefined rules with different constraints/thresholds specified on selection parameters (i.e., network resources/parameters) for optimally selecting the UPF for the PDU session.

The database 220 may include multiple storage units such as hard disks and/or solid-state disks in a redundant array of inexpensive disks (RAID) configuration. In some embodiments, the database 220 may include a storage area network (SAN) and/or a network attached storage (NAS) system. In one embodiment, the database 220 may correspond to a distributed storage system, wherein individual databases are configured to store custom information, such as, historical data related to suspended UPFs, UPF restoration policies, heartbeat information of each UPF, status of UPFs, subscription information, UPF profiles, other NF profiles, types of network resources/parameters associated with each network function, etc.

In some embodiments, the database 220 is integrated within the network element 200. For example, the network element 200 may include one or more hard disk drives as the database 220. In other embodiments, the database 220 is external to the network element 200 and may be accessed by the network element 200 using a storage interface (not shown in FIG. 2). The storage interface is any component capable of providing the processor 202 with access to the database 220. The storage interface may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 202 with access to the database 220.

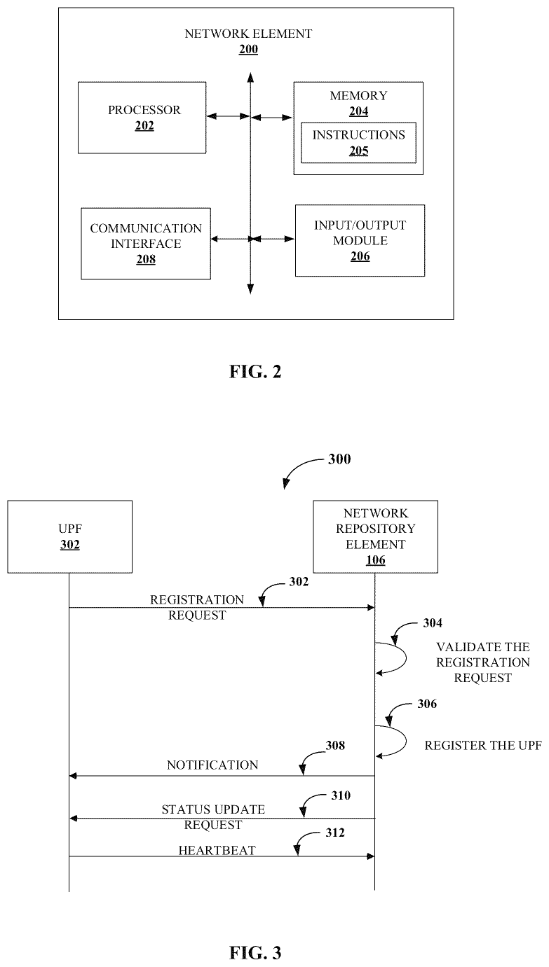

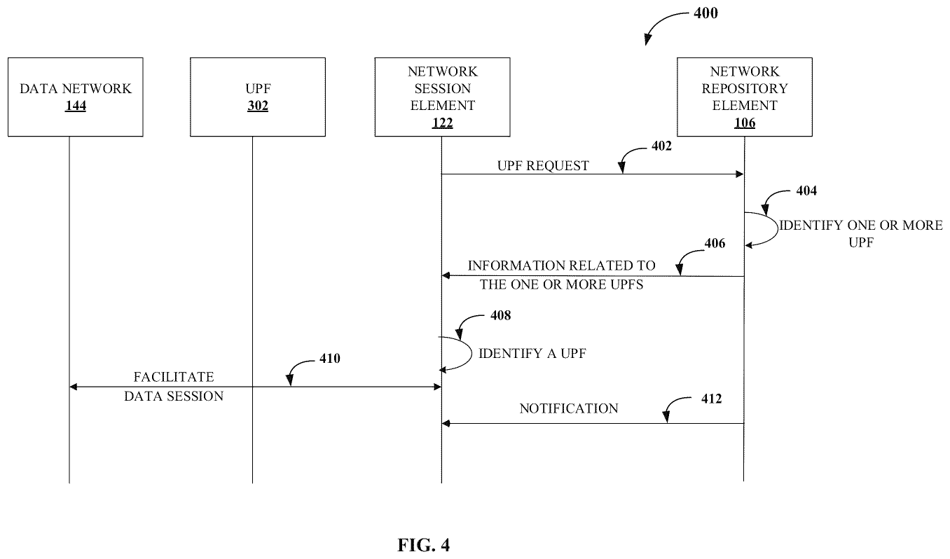

As already explained, the communication interface 208 is configured to receive registration request from a UPF for registration with the network repository element 106. In addition, the communication interface 208 is also configured to receive UPF request from the network session element 122. It shall be noted that the reception of the registration request from the UPF prior to reception of UPF request is explained herein for exemplary purposes and the UPF registration request may be received at a later time instant after receiving the UPF request. The communication interface 208 is configured to forward the registration request from the UPF to the processor 202. The processor 202 in conjunction with the instructions 205 stored in the memory 204 is configured to process the registration request and perform one or more functions as will be described herein. The processing of the UPF request will be explained later with reference to FIG. 4. A sequence flow diagram depicting registration of a UPF with the network repository element 106 is shown and explained next with reference to FIG. 3.

FIG. 3 illustrates a sequence flow diagram representing a method 300 for registration of an UPF 302 with the network repository element 106, in accordance with an embodiment of the present disclosure. Each UPF instance can register, update, or deregister their profiles in the network repository element 106. As such, each UPF registers a UPF profile in the network repository element 106 along with a list of services provided by the UPF.

At 302, a registration request is received from the UPF 302. The registration request comprises one or more UPF service types. More specifically, the registration request includes a UPF profile of the UPF 302. In general, the UPF profile includes one or more information elements such as, one or more attributes. For example, attributes such as, list of parameters supported by the UPF per SNSSAI, one or more SMF areas the UPF 302 can serve, a list of User Plane interfaces configured on the UPF 302, PDU session types supported by the UPF and one or more service types. It shall be noted that the attributes disclosed in the UPF profile are for exemplary purposes and the UPF profile may include fewer or more attributes, for example, general parameters related to dynamic load capacity, interworking with EPS capability. UPF relative static capacity, and the like.

In an embodiment, the one or more attributes are information elements in the UpfInfo. As such, the UPF service type is an Information element in UpfInfo. Some examples of the UPF service type include, but not limited to, international roaming, corporate services, enterprise services, Internet of Things (IoTs), immersive gaming, livestreaming media content subscribers, and the like. It shall be noted that examples of the UPF service described herein are for exemplary purposes and different types of UPF service type may be defined to suit a plurality of applications on an ad-hoc basis as specified by the 3GPP standard. For example, a category of subscribers, for example, government or defence organizations, may require a secure UPF specifically dedicated for their service and as such, a UPF may be defined for supporting such service types.

In an embodiment, the UPF 302 may support one or more service types. For example, the UPF 302 may be capable of supporting IoT subscribers and livestreaming media subscribers. For example, the UPF 302 has resources to support low latency, low loss and high data rate services and as such, the UPF may register with both different service types i.e., IoT service and livestreaming media services. Accordingly, both these service types may be indicated in the corresponding service type information element of UpfInfo. More specifically, the service type attribute may be added to UPF NFProfile attributes of UpfInfo defined in TS 29.510 as shown below in Table 1.

TABLE 1

| Attribute name | Data type | P | Cardinality | Description |
|---|---|---|---|---|
| ServiceType | array(String) | O | 1 . . . N | Using this attribute SMF + PGW-C |
| | | | | can select the available UPF using |
| | | | | NRF Discovery for different |
| | | | | services. Same UPF can be |
| | | | | configured with a plurality of |
| | | | | service types so that the SMF can |
| | | | | select as per requirement. |

It shall be noted that although the data type has been specified as string, any other data type may be used to indicate the service type of the UPF 302. For example, if the UPF 302 supports two different service types and data type is string, a string (e.g., “ab12cd”) may be used to represent each of these service types based on a look up table.

At 304, the network repository element 106 validates the registration request of the UPF 302.

At 306, the network repository element 106 registers the UPF 302 with the network repository element 106. More specifically, the network repository element 106 stores the UPF profile including the service type in a database or memory of the network repository element 106.

At 308, the network repository element 106 sends a notification to the UPF 302. The notification is an acknowledgement indicating registration of the UPF 302.

At 310, the network repository element 106 sends a status update request to the UPF 302. After the UPF is registered with the network repository element 106, the network repository element 106 may request status updates from the UPF 302 at defined time intervals, for example, every 2 minutes. As such, the status update request may be sent from the network repository element 106 to the UPF 302 at the defined time intervals. Alternatively, the network repository element 106 sends a status update request initially indicating to the UPF 302 to automatically share status updates at the defined time intervals. This ensures the network repository element 106 has a track of status of the UPF 302.

At 312, the UPF 302 sends a heartbeat to the network repository element 106. In an embodiment, the heartbeat may be sent in response to the status update request received from the network repository element 106. In another embodiment, the UPF 302 automatically sends the heartbeat after every defined time interval for providing a status update to the network repository element 106. IF the UPF 302 is operational, a status of the UPF 302 is updated as active and if the UPF 302 fails to send a heartbeat, then the UPF 302 status is updated as suspended. This ensures suspended UPFs are not selected for facilitating PDU sessions.

The sequence of operations of the method 300 need not be necessarily executed in the same order as they are presented. Further, one or more operations may be grouped together and performed in form of a single step, or one operation may have several sub-steps that may be performed in parallel or in sequential manner. Facilitating a PDU session for the UE 140 is explained next with reference to FIG. 4.

FIG. 4 illustrates a sequence flow diagram representing a method 400 for identifying a UPF for facilitating a Packet Data Unit (PDU) session, in accordance with an embodiment of the present disclosure. Selection of an UPF for a PDU session is an important step to ensure a seamless experience is provided to the user.

At 402, the network session element 122 sends a UPF request to the network repository element 106. In an embodiment, the UPF request is sent from the network session element 122 in response to a PDU session request from the UE. In an example, if the UE 140 requests a PDU session for accessing information from the DN 144, then the network session element 122 generates the UPF request. In another embodiment, the UPF request is sent as part of a subscription for at least one service type of UPF. More specifically, the network session element 122 may subscribe to receive information related to UPFs registered with the network repository element 106. In an embodiment, the UPF request includes at least one service type. For example, the UPF request from the network session element 122 may specify a service type of international roaming. It shall be noted that the UPF request may include more than one service type, for example, as part of subscription, the network session element 122 may send the UPF request including service types, international roaming subscribers, and IoT subscribers. In addition, the UPF request may include additional attributes for subscription such as, frequency of receiving the UPF, conditions associated with the subscription, and the like.

At 404, the network repository element 106 identifies one or more UPFs from the plurality of UPFs based on the UPF service type. More specifically, the plurality of user profiles associated with the plurality of UPFs registered with the network repository element 106 are searched to identify a set of UPFs associated with the UPF service type specified in the UPF request. After retrieving the set of UPFs, the network repository element 106 determines suspended UPFs based on a status of each UPF of the set of UPFs to identify one or more UPFs. In general, the network repository element 106 stores status of the plurality of UPFs in database, for example, the database 220. As such, the UPF may be in an active state and suspended state. The UPFs in the suspended state are excluded and the one or more UPFs which are active and provide the service type specified in the UPF request are identified.

At 406, the network repository element 106 sends information related to the one or more UPFs to the network session element 122. More specifically, one or more UPF profiles corresponding to the one or more UPFs are sent to the network session element 122 in response to the UPF request. It shall be noted that the information (i.e., the one or more UPF profiles) is sent in response to the subscription or request from UE 140 for the PDU session.

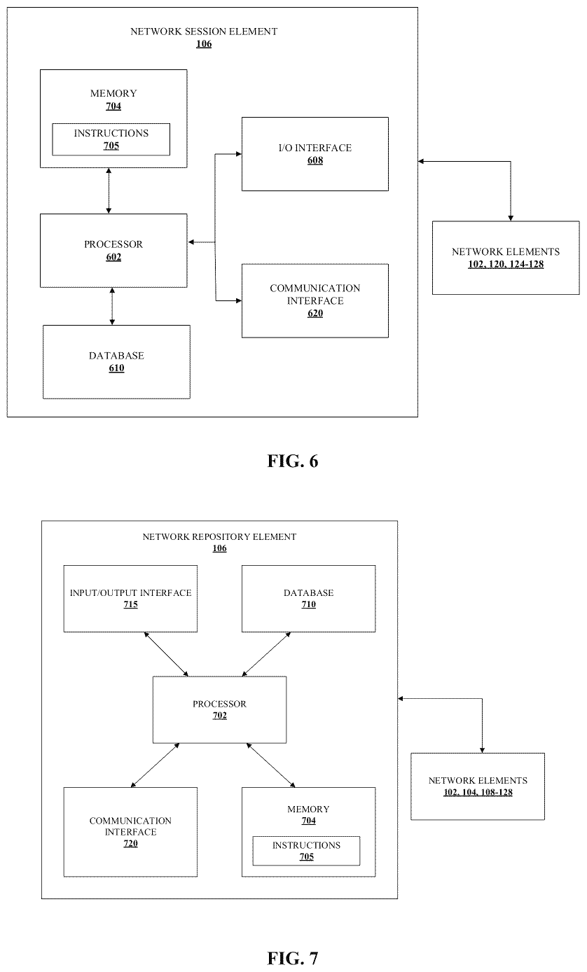

At 408, the network session element 122 identifies a UPF from the one or more UPFs based on the information and one or more selection parameters. Some examples of the selection parameters include, but not limited to, UPF's dynamic load, UPF load prediction, UPF's location, UPF relative static capacity, UE location information, functionality required for the PDU session, Data Network Name (DNN), PDU session type, SSC mode selected for the PDU session, UE subscription profile, local operator policies, access technology used by the UE, user plane latency requirements, and Access Traffic Steering, Switching and Splitting (ATSSS) steering capability for the PDU session. More specifically, the UPF which provides high QoS and a seamless experience for the user based on the PDU session requirements is selected. It shall be noted that if the UPF request is a subscription, then information related to the one or more UPFs are stored in a database (see, database 610 of FIG. 6) of the network session element 122. Whenever, a request for a PDU session is received, the network session element 122 selects a UPF (i.e., the UPF 302) from among the one or more UPFs of the service type required for the data session by the UE 140.

At 410, the network session element 122 facilitates a Protocol Data Unit (PDU) session. The PDU session is facilitated by the UPF 302 selected from among the one or more UPFs by the network session element 122.

At 412, the network repository element 106 sends a notification related to a new UPF registered with the at least one service type based on the subscription of the network session element 122. In an example, if the network session element 122 subscribes to receive information (i.e., user profiles) related to UPFs registered with a service type international roaming, then after validating the subscription, information related to one or more UPFs with the service type international roaming may be sent to the network session element 122. In another embodiment, a new UPF may register at a later time instant with service type international roaming. In such, scenarios, an update is sent to the network session element 122 with the user profile if the new UPF providing the service type of international roaming.

Although embodiments of the present disclosure describe selection of one or more UPFs based on service type of the UPF, it shall be noted that the UPF request may include other information elements that specify parameters/attributes for selection of the one or more UPFs. For example, SMF area identity may be used to determine if the UPF can provide service to area indicated by the SMF area identity. As such, only if the UPF matches all the attributes/parameters specified in the UPF request, the UPF may be selected. Moreover, it shall be noted that the service type of the UPF is only used to select the one or more UPFs from the network repository element 106 and selection of the UPF for facilitating the PDU session for the UE 140 may be based on the one or more selection parameters.

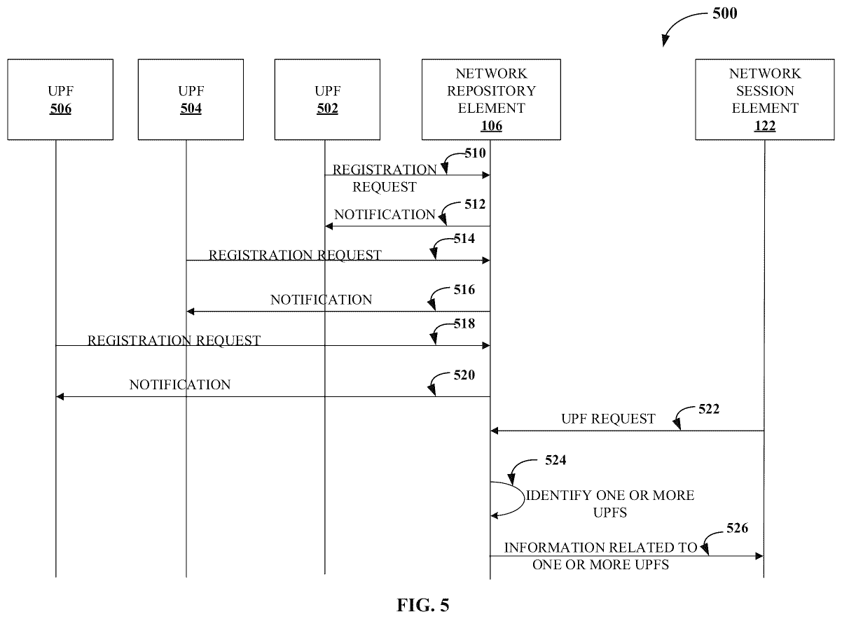

The sequence of operations of the method 400 need not be necessarily executed in the same order as they are presented. Further, one or more operations may be grouped together and performed in form of a single step, or one operation may have several sub-steps that may be performed in parallel or in sequential manner. An example scenario depicting identifying of one or more UPFs based on the UPF request is shown and explained with reference to FIG. 5.

FIG. 5 illustrates a sequence flow diagram representing an exemplary method 500 for identifying one or more UPFs from the plurality of UPFs based on a UPF service type international roaming, in accordance with an embodiment of the present disclosure.

At 510, a UPF 502 registers with the network repository element 106. In this example representation, the UPF 502 registers with a service type of international roaming in the UpfInfo. Registration process of an UPF with the network repository element 106 is explained with reference to FIG. 3 and is not explained herein for the sake of brevity.

At 512, the network repository element 106 sends a notification indicating completion of the registration process. Similarly, UPFs 504 and 506 register with the network repository element 106 at 514 and 518. The UPF 504 registers with a service type of immersive gaming and IoT services whereas the UPF 506 registers with a service type of international roaming and IoT services. As such, notification of registration is sent to the UPFs 504 and 506 at 516 and 520, respectively.

At 522, the network session element 122 sends a UPF request to the network repository element 106. The UPF request includes a service type specified as international roaming indicating that the network session element 122 is requesting for one or more UPFs providing services of international roaming.

At 524, the network repository element 106 identifies UPFs 502 and 506 providing service type of international roaming.

At 526, information related to the UPF 502 and 506 are sent to the network session element 122 in response to the UPF request. The network session element 122 selects an UPF from the one or more UPFs for a PDU session based on one or more selection parameters as explained with reference to FIG. 4. Block diagram representations of the network session element 122 and the network repository element 106 are described next with reference to FIGS. 6-7.

FIG. 6 illustrates a network session element 122 for user plane function selection based on service type for packet data unit sessions, in accordance with an embodiment of the present disclosure. The network session element 122 as explained herein comprises functionality of a Session Management Function (SMF) and Packet Data Network Gateway Control (PGW-C) and is depicted as SMF 122 in FIG. 1. The network session element 122 manages setup of the connectivity for the UE 140 towards the DN 144 as well as managing the UPF 130 for that connectivity. In general, the network session element 122 is the control function that manages the PDU sessions including establishment, modification and release of sessions. The network session element 122 communicates indirectly with the UE 140 through the AMF 120 that relays session-related messages between the UE 140 and the network session element 122.

The network session element 122 includes a processor 602 configured to extract programming instructions from a memory 604 to provide various features of the present disclosure. The components of the network session element 122 provided herein may not be exhaustive and that the network session element 122 may include more or fewer components than that of depicted in FIG. 6. Further, two or more components may be embodied in one single component, and/or one component may be configured using multiple sub-components to achieve the desired functionalities. Some components of the network session element 122 may be configured using hardware elements, software elements, firmware elements and/or a combination thereof.

Via a communication interface 620, the processor 602 is configured to: (1) send a UPF request to the network repository element 106, and (2) receive information related to the one or more UPFs from the network repository element 106. The communication may be achieved through API calls, without loss of generality. In an embodiment, the communication interface 620 is an SBI interface which may be the Nsmf. The network session element 122 communicates with one or more network elements in the 5G communication system such as, NFs 102, 104, 106, 108, 110, 112, 114, 116, 118, 120, 124, 126, and 128 for user plane function selection based on service type via the communication interface 620. As such, the network session element 122 interacts with other NFs in the 5G communication system to manage PDU sessions for UE's such as, the UE 140.

The memory 604 can be any type of storage accessible to the processor 602 to perform respective functionalities. For example, the memory 604 may include one or more volatile or non-volatile memories, or a combination thereof to store instructions 605 to: (1) send a UPF request including at least one service type to the network repository element 106, (2) receive information related to the one or more UPFs from the network repository element 106, (3) identify an UPF from the one or more UPFs based on the information and one or more selection parameters, (4) facilitating a PDU session for the UE 140 based on the UPF.

In an embodiment, the I/O interface 608 may include mechanisms configured to receive inputs from and provide outputs to peripheral devices such as, the plurality of NFs 102-128 of 5G communication system. Some example of the I/O interface 608 includes, but not limited to, a keyboard, a mouse, a keypad, a touch screen, soft keys, a microphone, a display and the like. The network session element 122 is depicted to be in operative communication with a database 610. In one embodiment, the database 610 is configured to store session management policies, subscription information, UPF profiles, UPF requests, and the like for managing PDU sessions.

In one embodiment, the memory 604 is capable of storing machine executable instructions, referred to herein as instructions 605. As such, the processor 202 is capable of executing the instructions 605 stored in the memory 604 to perform one or more operations described herein. The processor 602 is capable of processing information of one or more UPFs associated with a service type received from the network repository element 106 for identifying an UPF from the one or more UPFs based on one or more selection parameters for facilitating the PDU session. Further, the processor 602 manages the PDU session for example, establishment, modification and release of PDU session, for the UE 140 by communicating with the AMF 120 via the communication interface 620. A schematic block diagram of the network repository element 106 is shown and explained next with reference to FIG. 7.

FIG. 7 is a simplified block diagram of a network repository element 106 used for user plane function selection based on service type for Packet Data Unit (PDU) sessions, in accordance with an embodiment of the present disclosure. The network repository element 106 as described herein performs one or more functions of the NRF defined in 3GPP standards.

The network repository element 106 includes at least one processor 702 communicably coupled to a database 710, an Input/Output (I/O) interface 715, a communication interface 720 and a memory 704. The components of the network repository element 106 provided herein may not be exhaustive, and that the network repository element 106 may include more or fewer components than that of depicted in FIG. 7. Further, two or more components may be embodied in one single component, and/or one component may be configured using multiple sub-components to achieve the desired functionalities. Some components of the network repository element 106 may be configured using hardware elements, software elements, firmware elements and/or a combination thereof.

The I/O interface 715 may include mechanisms configured to receive inputs from and provide outputs to peripheral devices such as, the plurality of NFs 102-128 of 5G communication system and operators or service providers managing the network repository element 106. For instance, the I/O interface 715 may include at least one input interface and/or at least one output interface. Examples of the input interface may include, but are not limited to, a keyboard, a mouse, a joystick, a keypad, a touch screen, soft keys, a microphone, and the like. Examples of the output interface may include, but are not limited to, a UI display (such as a light emitting diode display, a thin-film transistor (TFT) display, a liquid crystal display, an active-matrix organic light-emitting diode (AMOLED) display, etc.), a speaker, a ringer, a vibrator, and the like.

The memory 704 can be any type of storage accessible to the processor 702. For example, the memory 704 may include volatile or non-volatile memories, or a combination thereof. In an embodiment, the memory 704 stores a plurality of UPF profiles associated with a plurality of UPFs registered with the network repository element 106. In an example, the UPFs may be categorized based on their service type and stored in the memory 704. More specifically, service type profiles (e.g., immersive gaming UPFs, secure UPFs, etc) may be created for each service type and list of UPFs registered with such service types may be added to the corresponding service type profile.

The database 710 is capable of storing and/or retrieving data, such as, but not limited to, store UPF registration policies for registering one or more UPFs with the network repository element 106, a plurality of UPF profiles related to a plurality of UPFs, subscription information received from one or more SMFs (e.g., the SMF 122), a status of each UPF of the plurality of UPFs, list of suspended UPFs, one or more predefined rules for selection of an UPF for a PDU session, and the like. Such information can be accessed by the processor 702 using the communication interface 720 to select an UPF based on service type for a PDU session of the UE 140.

The network repository element 106 is capable of communicating with one or more network elements in the 5G communication system such as, NFs 102, 104, 108, 110, 112, 114, 116, 118, 120, 122, 124, 126, and 128 for user plane function selection based on service type via the communication interface 720. The communication interface 720 is an SBI interface which may be a Nnrf. In an embodiment, the network repository element 106 communicates with the UPF 302 via the communication interface 720 for: (1) receiving a registration request from the UPF 302 including one or more service types of the UPF 302, (2) sending a notification of the registration of the UPF 302, and (3) receiving heartbeat from the UPF 302 providing status updates of the UPF 302. In an embodiment, the network repository element 106 communicates with the network session element 122 via the communication interface 720 to: (1) receive a UPF request from the network session element 122, (2) send information related to the one or more UPFs to the network session element 122, and (3) send a notification related to a new UPF registered with the NRF 106. It shall be noted that the network repository element 106 provides services to other NFs in the 5G communication system such as, registration, deactivation, updation and is not explained herein.

In one embodiment, the communication interface 720 includes a transceiver for wirelessly communicating information to, or receiving information from, the network session element 122 or other network NFs 102, 104, 108, 110, 112, 114, 116, 118, 120, 122, 124, 126, and 128. In another embodiment, the communication interface 720 is capable of facilitating operative communication with the NFs 102, 104, 108, 110, 112, 114, 116, 118, 120, 122, 124, 126, and 128 and a cloud server using Application Program Interface (API) calls. The communication may be achieved over a communication network.

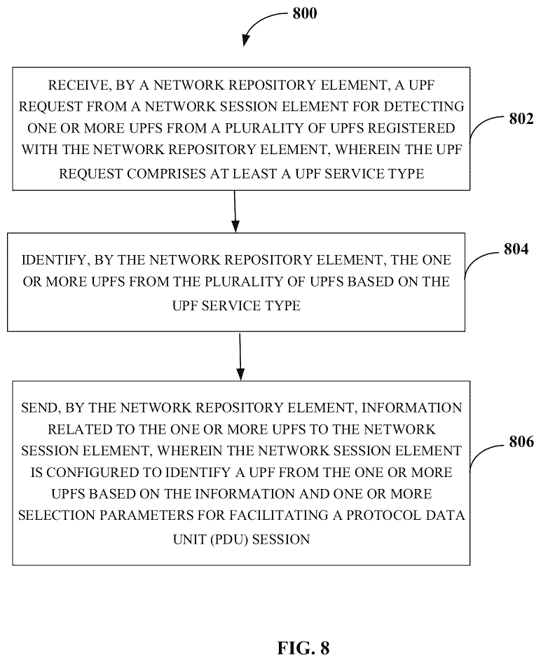

The processor 702 is capable of processing registration requests to register a UPF with the network repository element 106. For example, the processor 702 is configured to receive one or more attributes related to the UPF specified in the UpfInfo, validate the registration request and store a UPF profile with the one or more attributes in the database 710. When the network repository element 106 receives a UPF request including a service type, the processor 702 can access the database 710 to retrieve one or more UPF profiles of one or more UPFs associated with the service type. In the process, the processor 702 excludes suspended UPFs identified based on status of each of the UPF and sends the information (i.e., one or more UPF profiles) related to the one or more UPFs to the network session element 122 via the communication interface 720. A method for user plane function selection by the network repository element 106 is shown and explained next with reference to FIG. 8.

FIG. 8 is a flowchart illustrating a method 800 for user plane function selection based on service type for Packet Data Unit (PDU) sessions, in accordance with an embodiment of the present disclosure. The method 800 depicted in the flow diagram may be executed by, for example, the network repository element 106. Operations of the flow diagram, and combinations of operation in the flow diagram, may be implemented by, for example, hardware, firmware, a processor, circuitry and/or a different device associated with the execution of software that includes one or more computer program instructions. The operations of the method 800 are described herein with help of the processor 702 embodied within the network repository element 106. It is noted that the operations of the method 800 can be described and/or practiced by using one or more processors of a system/device other than the network repository element 106, for example, a different network elements (i.e., NFs 102, 104, 108-128) communicably coupled with the network session element 122. The method 800 starts at operation 802.

At operation 802 of the method 800, a UPF request is received by a network repository element such as, the network repository element 106 or network element 200, from the network session element 122 for detecting one or more UPFs from a plurality of UPFs registered with the network repository element 106. The UPF request comprises at least a UPF service type. The network repository element 106 is shown and explained with reference to FIGS. 2-5, and 7.

At operation 804 of the method 800, the one or more UPFs from the plurality of UPFs are identified based on the UPF service type. Identifying the one or more UPFs from among the plurality of UPFs is explained in detail with reference to FIG. 4 and is not explained herein for the sake of brevity.

At operation 806 of the method 800, information related to the one or more UPFs is sent to the network session element 122. The network session element 122 is configured to identify a UPF from the one or more UPFs based on the information and one or more selection parameters for facilitating a Packet Data Unit (PDU) session.

The sequence of operations of the method 800 need not be necessarily executed in the same order as they are presented. Further, one or more operations may be grouped together and performed in form of a single step, or one operation may have several sub-steps that may be performed in parallel or in sequential manner.

The disclosed method with reference to FIG. 8, or one or more operations of the network session element 122 explained with reference to FIGS. 2-4 may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as Flash memory components) and executed on a computer (e.g., any suitable computer, such as a laptop computer, net book, Web book, tablet computing device, smart phone, or other mobile computing device). Such software may be executed, for example, on a single local computer.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, CD (Compact Disc) ROMs, DVDs, flash drives, disks, and any other known physical storage media.

In an embodiment, a network repository element 106 is disclosed. The network repository element 106 includes a memory 704 and a processor 702. The memory 704 is configured to store instructions 705 and a plurality of User Plane Functions (UPFs) registered with the network repository element 106. The processor 702 is configured to execute the instructions 705 stored in the memory 704 to: receive a UPF request from a network session element 122 for detecting one or more UPFs from the plurality of UPFs. The UPF request includes at least a UPF service type. The processor 702 is configured to identify the one or more UPFs from the plurality of UPFs based on the UPF service type. The processor 702 is configured to send information related to the one or more UPFs to the network session element 122. The network session element 122 is configured to identify a UPF from the one or more UPFs based on the information and one or more selection parameters for facilitating a Packet Data Unit (PDU) session.

In an embodiment, the processor 702 is configured to receive a registration request from an UPF. The registration request comprises one or more UPF service types. The processor 702 registers the UPF with the one or more UPF service types based on the registration request.

In an embodiment, the processor 702 is configured to receive the UPF request from the network session element 122 in response to a PDU session request from an User Equipment 140. In another embodiment, the processor 702 is configured to receive the UPF request as part of a subscription for at least one service type of UPF.

In an embodiment, the processor 702 is configured to send a notification related to a new UPF registered with the at least one service type based on the subscription of the network session element 122.

In an embodiment, the processor 702 is further configured to determine suspended UPFs based on a status of each UPF to identify the one or more UPFs.

In an embodiment, the UPF service type is an Information element in UpfInfo.

In an embodiment, network session element 122 comprises a Session Management Function (SMF) and Packet Data Network Gateway Control (PGW-C).

In another embodiment, a method is disclosed. The method includes receiving, by a network repository element 106, a UPF request from a network session element 122 for detecting one or more UPFs from a plurality of UPFs registered with the network repository element 106. The UPF request includes at least a UPF service type. The method includes identifying, by the network repository element 106, the one or more UPFs from the plurality of UPFs based on the UPF service type. The method includes sending, by the network repository element 106, information related to the one or more UPFs to the network session element 122. The network session element 122 is configured to identify a UPF from the one or more UPFs based on the information and one or more selection parameters for facilitating a Packet Data Unit (PDU) session.

In an embodiment, the UPF request is received from the network session element 122 in response to a PDU session request from an User Equipment 140. In another embodiment, the UPF request is received from the network session element 122 as part of a subscription for at least one service type of UPF.

In an embodiment, the method includes sending, by the network repository element 106, a notification related to a new UPF registered with the at least one service type based on the subscription of the network session element 122.

In an embodiment, the method includes determining, by the network repository element 106, suspended UPFs based on a status of each UPF to identify the one or more UPFs.

In yet another embodiment, a system is disclosed. The system includes a network session element 122 and a network repository element 106. The network repository element 106 stores a plurality of User Plane Functions (UPFs) registered with the network repository element 106. The network repository element 106 is communicably coupled with the network session element 122. The network repository element 106 is configured to receive a UPF request for detecting one or more UPFs from the plurality of UPFs. The UPF request includes at least a UPF service type. The network repository element 106 is configured to identify the one or more UPFs from the plurality of UPFs based on the UPF service type. The network repository element 106 is configured to send information related to the one or more UPFs to the network session element 122. The network session element 122 is configured to identify a UPF from the one or more UPFs based on the information and one or more selection parameters for facilitating a Packet Data Unit (PDU) session.

In an embodiment, the network repository element 106 is configured to receive a registration request from an UPF. The registration request comprises one or more UPF service types. The network repository element 106 registers the UPF with the one or more UPF service types based on the registration request.

In an embodiment, the network repository element 106 is configured to receive the UPF request from the network session element 122 in response to a PDU session request from an User Equipment 140. In another embodiment, the network repository element 106 is configured to receive the UPF request as part of a subscription for at least one service type of UPF.

In an embodiment, the network repository element 106 is configured to send a notification related to a new UPF registered with the at least one service type based on the subscription to the network session element 122.

In an embodiment, the network repository element 106 is further configured to determine suspended UPFs based on a status of each UPF of a set of UPFs associated with the at least one service type to identify the one or more UPFs from the plurality of UPFs.

Various embodiments of the present disclosure provide numerous advantages. Embodiments of the present disclosure enable user plane function selection based on service type for packet data unit sessions. The introduction of an attribute to indicate one or more service types of the UPF while registration ensures UPF profiles are updated with service type and provides options to discover UPFs based on the service type of UPF required for the user or the PDU session. Such dedicated UPFs for various functionalities/applications such as, immersive media, IOT, international roaming services and the like, ensures improved service for the users whilst keeping resource requirements of the applications. Further, each UPF may be associated with more than one service type thereby enabling flexibility and efficient usage of UPFs for managing PDU sessions. Furthermore, suspended UPFs which are non-operational are identified and are not provided for initiating PDU sessions which reduces latency in establishing PDU sessions. Moreover, the network repository element 106 identifies and selects UPFs for a PDU session based on the attribute-service type indicated in the UPF request which significantly enhances the user experience and enhances QoS provided to the users. In general, packet processing and traffic management are enhanced when dedicated UPFs are sued based on service type requirements of the UE 140 for each PDU session, which provides a seamless experience for the user of 5G communication system.

It will be understood by those within the art that, in general, terms used herein, and are generally intended as “open” terms (e.g., the term “including” should be interpreted as “including but not limited to,” the term “having” should be interpreted as “having at least.” the term “includes” should be interpreted as “includes but is not limited to.” etc.). For example, as an aid to understanding, the detail description may contain usage of the introductory phrases “at least one” and “one or more” to introduce recitations. However, the use of such phrases should not be construed to imply that the introduction of a recitation by the indefinite articles “a” or “an” limits any particular part of description containing such introduced recitation to disclosure containing only one such recitation, even when the introductory phrases “one or more” or “at least one” and indefinite articles such as “a” or “an” (e.g., “a” and/or “an” should typically be interpreted to mean “at least one” or “one or more”) are included in the recitations; the same holds true for the use of definite articles used to introduce such recitations. In addition, even if a specific part of the introduced description recitation is explicitly recited, those skilled in the art will recognize that such recitation should typically be interpreted to mean at least the recited number (e.g., the bare recitation of “two recitations,” without other modifiers, typically means at least two recitations or two or more recitations).

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following detailed description.

What is claimed is:

1. A network repository element, comprising:
a memory configured to store instructions and a plurality of User Plane Functions (UPFs) registered with the network repository element; and
a processor configured to execute the instructions stored in the memory to:
receive a UPF request from a network session element for detecting one or more UPFs from the plurality of UPFs, wherein the UPF request comprises at least a UPF service type,
identify the one or more UPFs from the plurality of UPFs based on the UPF service type; and
send information related to the one or more UPFs to the network session element,
wherein the network session element is configured to identify a UPF from the one or more UPFs based on the information and one or more selection parameters for facilitating a Packet Data Unit (PDU) session.

2. The network repository element as claimed in claim 1, wherein the processor is configured to:
receive a registration request from an UPF, wherein the registration request comprises one or more UPF service types; and
register the UPF with the one or more UPF service types based on the registration request.

3. The network repository element as claimed in claim 1, wherein the processor is configured to receive the UPF request from the network session element in response to a PDU session request from an User Equipment.

4. The network repository element as claimed in claim 1, wherein the processor is configured to receive the UPF request as part of a subscription for at least one service type of UPF.

5. The network repository element as claimed in claim 1, wherein the processor is configured to:
send a notification related to a new UPF registered with the at least one service type based on the subscription of the network session element.

6. The network repository element as claimed in claim 1, wherein the processor is further configured to:
determine suspended UPFs based on a status of each UPF to identify the one or more UPFs.

7. The network repository element as claimed in claim 1, wherein the UPF service type is an Information element in UpfInfo.

8. The network repository element as claimed in claim 1, wherein the network session element comprises a Session Management Function (SMF) and Packet Data Network Gateway Control (PGW-C).

9. A method, comprising:
receiving, by a network repository element, a UPF request from a network session element for detecting one or more UPFs from a plurality of UPFs registered with the network repository element, wherein the UPF request comprises at least a UPF service type,
identifying, by the network repository element, the one or more UPFs from the plurality of UPFs based on the UPF service type; and
sending, by the network repository element, information related to the one or more UPFs to the network session element,
wherein the network session element is configured to identify a UPF from the one or more UPFs based on the information and one or more selection parameters for facilitating a Packet Data Unit (PDU) session.

10. The method as claimed in claim 9, comprising:
receiving, by the network repository element, a registration request from an UPF, wherein the registration request comprises one or more UPF service types; and
registering, by the network repository element, the UPF with the one or more UPF service types based on the registration request.

11. The method as claimed in claim 9, wherein the UPF request is received from the network session element in response to a PDU session request from an User Equipment.

12. The method as claimed in claim 9, wherein the UPF request is received from the network session element as part of a subscription for at least one service type of UPF.

13. The method as claimed in claim 9, further comprising:
sending, by the network repository element, a notification related to a new UPF registered with the at least one service type based on the subscription of the network session element.

14. The method as claimed in claim 9, further comprising:
determining, by the network repository element, suspended UPFs based on a status of each UPF to identify the one or more UPFs.

15. A system, comprising:
a network session element; and
a network repository element storing a plurality of User Plane Functions (UPFs) registered with the network repository element, wherein the network repository element is communicably coupled with the network session element and is configured to:
receive a UPF request for detecting one or more UPFs from the plurality of UPFs, wherein the UPF request comprises at least a UPF service type,
identify the one or more UPFs from the plurality of UPFs based on the UPF service type; and
send information related to the one or more UPFs to the network session element,
wherein the network session element is configured to identify a UPF from the one or more UPFs based on the information and one or more selection parameters for facilitating a Packet Data Unit (PDU) session.

16. The system as claimed in claim 15, wherein the network repository element is configured to:
receive a registration request from an UPF, wherein the registration request comprises one or more UPF service types; and
register the UPF with the one or more UPF service types based on the registration request.

17. The system as claimed in claim 15, wherein the network repository element is configured to receive the UPF request from the network session element in response to a PDU session request from an User Equipment.

18. The system as claimed in claim 15, wherein the network repository element is configured to receive the UPF request as part of a subscription for at least one service type of UPF.

19. The system as claimed in claim 15, wherein the network repository element is configured to:
send a notification related to a new UPF registered with the at least one service type based on the subscription to the network session element.

20. The system as claimed in claim 15, wherein the network repository element is further configured to:
determine suspended UPFs based on a status of each UPF of a set of UPFs associated with the at least one service type to identify the one or more UPFs from the plurality of UPFs.
